(19) United States
(12) Patent Application Publication
(10) Pub. No.: US 2012/0304716 A1
(43) Pub. Date: Dec. 6, 2012

(54) PROGRAMMABLE CYLINDER LOCK HAVING A MODIFIED CHANGE POSITION

(75) Inventor: Alberto Loreti, Antrodoco (IT)

(73) Assignee: RIELDA SERRATURE S.R.L., Fiumicino (IT)

(21) Appl. No.: 13/578,031

(22) PCT Filed: Dec. 8, 2010
(86) PCT No.: PCT/EP10/07623

§ 371 Date: Aug. 9, 2012

(30) Foreign Application Priority Data
Feb. 10, 2010 (IT) TO 2010 A 000091

(51) Int. Cl. E05B 21/06

(52) U.S. Cl. 70/492

(57) ABSTRACT

A lock with a programming device, includes a stator (1) a rotor (2), mounted inside the stator, a keyhole for a key (3), a longitudinal groove of stator, a series of key followers (4) and a series of locking pins (6) which, under control of a change bar (11), can be mutually engaged for normal operation or disengaged in a change position, and which can be made movable or blocked under control of a stop bar (9) provided with springs which stress the same outwards. There are provided two separate grooves, a change groove (12) and a stop groove (14) machined in rotor (2), and the grooves, the stop bar (9) and change bar (11) have such conformations that are positively prevented the cooperation of the stop bar (9) with the change groove (12) and the cooperation of the change bar (11) with the stop groove (14).

### BACKGROUND OF THE INVENTION

The subject of this invention is a programmable cylinder lock, namely a lock comprising devices intended to allow, through a change operation, to modify the former lock codification in order to adjust the lock for being operated by a key different from the key to which the lock was formerly adapted.

More particularly, the invention concerns improvements in a kind of programmable cylinder lock which is known from the European Patents Nos. 0.226.252 and 0.900.310.

The kind of locks to which applies the present invention is a lock with a programming device, which comprises a stator, a bore provided in said stator, a rotor rotatably mounted in said stator bore and a keyhole hollowed in said rotor, and wherein the programming device comprises in the stator a longitudinal groove made in said stator bore and a series of stator seats, which in case can contain counterpins and the respective springs, and comprises in the rotor:—a series of first seats intersecting said keyhole and a series of second seats parallel to said first seats;—a first slot and a second slot, orthogonal with respect to said seats and parallel to the rotor axis;—a series of key followers inserted with longitudinal and transversal mobility in said first rotor seats for cooperating with the conformations of a key inserted into said keyhole, each key follower having on one side some projections and on the other side an element for sliding engagement, and having an associated spring;—a series of locking pins slidingly inserted in said second rotor seats corresponding to said stator seats and possible counterpins and having a series of first recesses facing said projections of the key followers and a series of second recesses turned on the side opposite said key followers;—a stop bar inserted in said first rotor slot, having projections facing said second recesses of the locking pins, and a projection turned on the side opposite said locking pins and suitable for cooperating with said stator groove for allowing an outward displacement of the stop bar;—first springs associated to said stop bar and stressing the same outwards;—a change bar, inserted in said second rotor slot, having slidable engagement elements engaged with said sliding engagement elements of the key followers, and having a projection turned on the side opposite the key followers and suitable for cooperating with said stator groove for allowing an outward displacement of the change bar;—said component parts being coordinated in such a way that said projections of the stop bar engage said second recesses of the locking pins when the projection of the stop bar does not correspond to said stator groove, and disengage therefrom when the stop bar corresponds to said stator groove, displaces outwards under action of said first springs and determines for the lock a position for insertion and retraction of the key, whereas said key followers engage said second recesses of the locking pins when the projection of the change bar does not correspond to said stator groove and disengage therefrom when said change bar corresponds to said stator groove, displaces outwards by dragging with them the key followers by action of the respective sliding engagement elements, and determines for the lock a position of key change in which said key followers are disengaged from said locking pins and allow replacing the key with consequent different programming of the lock.

In these known programmable locks, the change position is attained by effecting a rotation by 180° of the key, because the change bar should arrive in correspondence of the single groove in which, in the rest conditions, penetrates the stop bar. Therefore, when the lock is in the change position, the change bar engages the stator groove, displaces outwards, cancels the lock programming and allows a different programming.

However, some lock mechanisms do not allow that the key is rotated by 180° without the mechanisms themselves being brought in inopportune or unacceptable positions. In the presence of such mechanisms it would be needed to provide a change position suitable for being attained by a rotation of the key substantially smaller that 180°. This would require that, in the change position, the change bar finds a stator groove situated in a position different from the position of the groove with which cooperates the stop bar. But, if two grooves are hollowed in the stator, both the stop bar and the change bar would engage in succession two different grooves during the key rotation, and this would lead to troubles for the lock operation, and also to unnecessary disturbing noises.

The document US 2005/217330 A1 describes a device having the purpose of reducing the stated drawbacks, this device corresponding substantially to the preamble of the appended claim 1.

### SUMMARY OF THE INVENTION

The general object of this invention is to improve the known locks of the considered kind in order to make up for the stated drawbacks by using very simple means.

More particularly, the main object of the invention is to provide by simple means a change position corresponding to a rotation of the key by an angle substantially smaller than 180°, preferably by an angle of 90°, however by preventing any trouble to the lock operation and any unnecessary noise.

This object is attained, in a lock of the kind stated in the preamble, in that there are provided two separate grooves formed in the stator, a first change groove intended to cooperate with the change bar and a second stop groove intended to cooperate with the stop bar, and that said stop groove and change groove and the stop bar and change bar have such conformations that the stop bar can cooperate with the stop groove and the change bar can cooperate with the change groove, whereas are positively prevented the cooperation of the stop bar with the change groove and the cooperation of the change bar with the stop groove, because a first groove between the two grooves is interrupted along its length by at least one projection, and the corresponding first bar is provided with corresponding notches suitable for allowing it to penetrate into the first groove, whereas the second bar is lacking such notches and therefore it cannot enter the first groove, whereas the second groove and the corresponding second bar have a length larger than the length of the first groove and of the first bar, whereby the second bar cannot enter the first groove.

In this way, during the rotation of the key, the stop bar passes in correspondence of the change groove when it passes through the change position, but it crosses the change groove without entering the same, whereas the change bar, on its turn, passes during the key rotation through the stop groove without entering the same. In such conditions, the change groove can be situated at any desired position and, preferably, it may be situated in correspondence of a key rotation of 90°. Therefore, the desired arrangement of the change position is attained without introducing any trouble in the lock operation and by producing no unnecessary noise. Thus, the lock can be adapted to any mechanism even if having special requirements.

Preferably, said grooves are angularly displaced the one with respect to the other, with reference to the stator axis, by an angle of 90°.

### BRIEF DESCRIPTION OF THE DRAWINGS

These and other features, objects and advantages of the subject of the present invention will more clearly appear from the following description of a preferred embodiment, being a not limiting example, with reference to the accompanying drawings, wherein:

FIG. 1 represents, for the purpose of reference, a cross section of a programmable cylinder lock known from the European Patent No. 0.900.310, in a condition of normal operation, with the correct key inserted.

FIG. 2 shows a diagrammatic perspective of the stator of a lock according to the invention.

FIG. 3 shows in perspective a lock according to the invention, with the key inserted, in the position of rest.

FIG. 4 shows a cross section taken along line IV-IV of FIG. 3.

FIG. 5 shows in perspective the lock according to the invention, with the key rotated in the change position.

FIG. 6 shows a cross section taken along line VI-VI of FIG. 5.

FIG. 7 shows in perspective a lock according to the invention, with the key rotated in the position in which the change bar faces the stop groove.

FIG. 8 shows a cross section taken along line VIII-VIII of FIG. 7.

FIG. 9 shows in perspective a lock according to the invention, with the key rotated in the position in which the stop bar faces the change groove.

FIG. 10 is a cross section taken along line X-X of FIG. 9.

### DETAILED DESCRIPTION OF THE PREFERRED EMBODIMENT

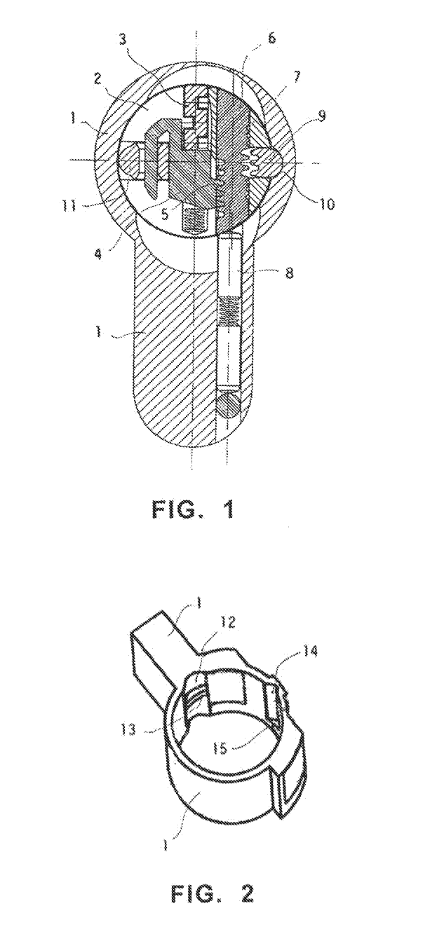

At first, reference to FIG. 1 will be made in order to recall the general structure and the operation of a lock of the considered kind, for whose particulars reference is made to the cited documents. Number 1 designates a stator inside which there is rotatably mounted a rotor 2 susceptible of receiving in its keyhole a key 3. Inside rotor 2 are mounted a number of key followers 4 lying in a plane perpendicular to the axis of rotor 2 and having mobility along their own longitudinal and transversal directions. The key followers 4 are intended to cooperate with the codification conformations of key 3. In addition, inside rotor 2 are mounted a corresponding number of locking pins 6, each locking pin being coplanar with one of the key followers 4 and having mobility along its own longitudinal direction. In the shown case, the locking pins 6 cooperate with counterpins 8 and, together with them, form the blocking members of the lock. The key followers 4 have a toothing 5, the locking pins have a toothing 7, and these toothings are intended to mutually cooperate. This cooperation may take place in different relative positions, in order to determine the lock codification. A stop bar 9 is displaceable in a transverse direction within rotor 2. is susceptible to cooperate with a longitudinal groove 10 of stator 1 by entering the same as shown in FIG. 1, has protrusions intended for cooperating with recesses of the locking pins 6, and serves for immobilizing the locking pins 6 when rotor 2 is made to rotate within stator 1 and, as a consequence, the stop bar 9 comes out of said groove 10 and engages the locking pins 6. A change bar 11 which is transversally displaceable in rotor 2 is slidingly coupled with the key followers 4, and normally the change bar 11 keeps the key followers 4 engaged with the locking pins 6 as shown by FIG. 1 but, when said change bar 11, due to a rotation of rotor 2, comes to correspond to said groove 10 of stator 1 and penetrates therein, it transversally displaces the key followers 4 and disengages the same from the locking pins 6. Then, by means of the replacement of the former key 3 by a different key, it is possible to modify the lock codification.

As it may be remarked, in stator 1 there is provided a single groove 10, which is intended to cooperate both with the stop bar 9 and with the change bar 11. Because the two bars 9 and 11 are situated in rotor 2 in diametrically opposite positions, the fact that there is a sole groove 10 involves that the key 3 along with rotor 2 is to be rotated by 180° in order to attain the change position.

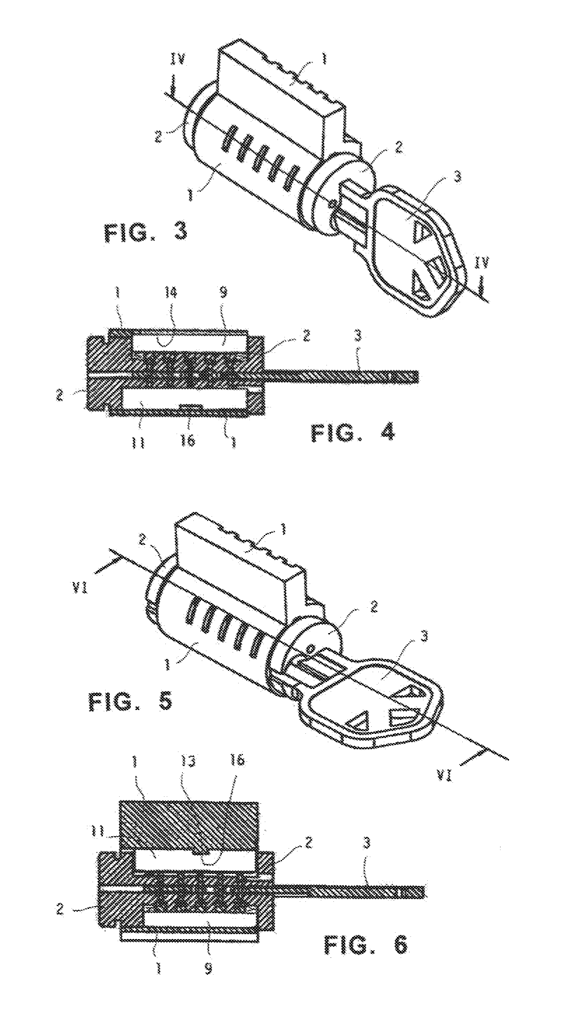

In FIGS. 3 to 10, which refer to the lock according to the invention, the component parts corresponding to those of FIG. 1 are designated by the same references.

Unlike the above described known locks, a lock according to the invention has in stator 1 two separate grooves 12 and 14. Groove 12 is intended to cooperate with the change bar 11, whereas groove 14 is intended to cooperate with the stop bar 9. Groove 14 intended to cooperate with the stop bar 9 is situated in its conventional position (the position 10 according to FIG. 1) whereas groove 12 intended to cooperate with the change bar 11 is angularly displaced of a certain angle around the stator axis with respect to groove 14. Said angle defines the angle of which is to be rotated the key from its rest position for bringing the lock into the change position. In the preferred form represented, this angle is of 90°, however of course any different angle may be chosen if this turns needed or suitable.

As it may be remarked from FIG. 2, groove 12 intended to cooperate with the change bar 11 has a projection 13 which interrupts its extension, whereas, on its turn, groove 14 intended to cooperate with the stop bar 9 has a reduced length; it is noted, in fact, that it is limited by an end border 15. As it will appear from the following Figures, the stop bar 9 and the change bar 11 have each one conformations that are complementary to those of the groove with which they are intended to cooperate, whereby each bar can enter only the groove intended for it and cannot enter the groove intended for the other bar.

FIGS. 3 and 4 refer to the lock in the rest position, with key 3 inserted in rotor 2. As it may be remarked from FIG. 4, the stop bar is inserted into the stop groove 14, whereas the change bar 11, which has a recess 16 and is longer than the stop bar 9, in the position of this Figure does not correspond to any groove and it rests against the wall of stator 1. This position corresponds to that of FIG. 1.

FIGS. 5 and 6 correspond to the condition in which key 3 along with rotor 2 has been rotated by 90° from the rest position. As it may be remarked from FIG. 6, the change bar 11 has arrived to correspond to the change groove 12, of which only the projection 13 is noticed, and the change bar has entered the change groove. This is possible because the change bar 11 has a recess 16 which is complementary to the projection 13 of groove 12. On its turn, in the position of this Figure the stop bar 9 does not correspond to any groove and it rests against the wall of stator 1.

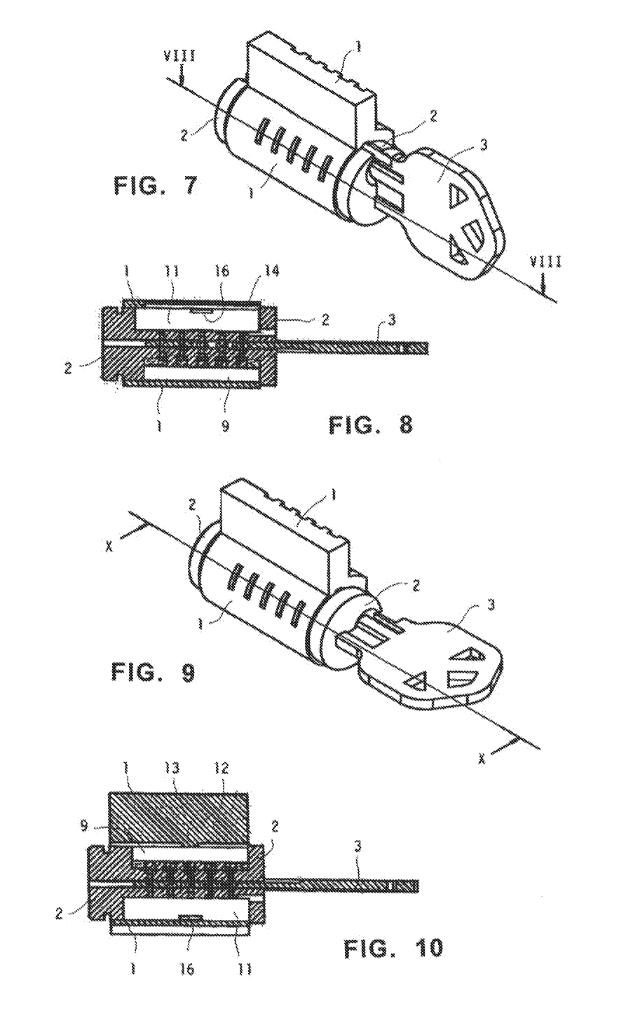

FIGS. 7 and 8 correspond to the condition in which key 3 along with rotor 2 has been again rotated by further 90° from the position of FIGS. 5 and 6. In this position, the stop bar 9 corresponds to the change groove 12, but it cannot enter the same because it is hindered by the projection 13. On its turn, in the position of this Figure the change bar 11 does not correspond to any groove and it rests against the wall of stator 1.

FIGS. 9 and 10 correspond to the condition in which key 3 along with rotor 2 has been again rotated by further 90° from the position of FIGS. 7 and 8. In this position, the change bar 11 corresponds to the stop groove 14, but it cannot enter the same because the length of the change bar exceeds the length of the stop groove 14. On its turn, in the position of this Figure the stop bar 9 does not correspond to any groove and it rests against the wall of stator 1.

As it appears from the foregoing, although in stator 1 are hollowed two grooves 12 and 14, each of the stop bar 9 and the change bar 11 can cooperate only with the groove intended for this bar, and it does not cooperate with the groove intended for the other bar. Therefore no trouble takes place in the lock operation, and all unnecessary noises are avoided, which result from the fall of the bars into the grooves. Therefore the object proposed by the invention is attained by simple means.

It is to be understood that the features described for the stop groove and the change groove, and correspondingly for the stop bar and the change bar, could be inverted among them, and that other conformation differences between the two bars and between the two grooves could be chosen in designing the lock. For example, the grooves and the bars could be different in the number and position of projections and corresponding recesses. The described features have been selected and preferred due to the easy in the manufacture of the parts. It is only basical the fact that two separate grooves are provided in the stator, a first change groove intended to cooperate with the change bar and a second stop groove intended to cooperate with the stop bar, and that said grooves for stop and for change, and the bars for stop and for change, have such conformations that the stop bar can cooperate with the stop groove and the change bar can cooperate with the change groove, whereas are positively prevented the cooperation of the stop bar with the change groove and the cooperation of the change bar with the stop groove.

It should be understood that this invention is not limited to the embodiment described and shown as an example. Several possible modifications have been pointed out in the course of the description, and others are within the ability of those skilled in the art. These modification and others, and any replacement by technically equivalent means, can be made to what has been described and shown, without departing from the spirit of the invention and the scope of this Patent as defined by the appended Claims.

1. A programmable cylinder lock of the type comprising a stator (1) and a cylindrical rotor (2), mounted inside the stator (1) for rotation around its own axis and having a keyhole extending in the axis direction for insertion of a key (3), and comprising inside rotor (1) a number of key followers (4) movable along their own longitudinal and transversal directions, intended to cooperate with the codification conformations of a key (3) inserted into the keyhole of rotor (2), and a number of locking pins (6) movable along their own longitudinal direction, which form the lock blocking members, said key followers (4) and locking pins (6) forming together a number of pairs each including a locking pin (6) and a key follower (4) and having toothings (7,5) intended to mutually cooperate, in different relative positions, in order to define the lock codification, the rotor (2) including a transversally displaceable stop bar (9) cooperating with a longitudinal groove of stator (1) and having projections susceptible of cooperating with notches of the locking pins (6) in order to immobilize the locking pins (6) when rotor (2) is made to rotate within stator (1) and the stop bar (9) comes out of said groove and engages the locking pins (6), and comprising a change bar (11) which is transversally displaceable and is slidingly coupled with the key followers (4) in order to normally keeping the key followers (4) engaged with the locking pins (6) and to disengage the key followers (4) from the locking pins (6) when said change bar (11) comes into a groove of stator (1) and provides a lock programming position, and in which there are provided two separate grooves (12 and 14) formed in the stator (1), a first change groove (12) intended to cooperate with the change bar (11) and a second stop groove (14) intended to cooperate with the stop bar (9), and that said stop groove (14) and change groove (12) and the stop bar (9) and change bar (11) have such conformations that the stop bar (9) can cooperate with the stop groove (14) and the change bar (11) can cooperate with the change groove (12), whereas are positively prevented the cooperation of the stop bar (9) with the change groove (12) and the cooperation of the change bar (11) with the stop groove (14),
characterized in that a first groove between the change groove (12) and the stop groove (14) is interrupted along its length by at least one projection (13), and the corresponding first change bar (11) or stop bar (9) is provided with corresponding notches (16) suitable for allowing it to penetrate into the first groove (12 or 14), whereas the second stop bar (9) or change bar (11) is lacking such notches and therefore cannot penetrate into the first change groove (12) or stop groove (14), and the second groove (14 or 12) and the corresponding second bar (9 or 11) have a length larger than the length of the first groove (12 or 14) and of the first bar (11 or 9), whereby the second bar (9 or 11) cannot penetrate into the first groove (12 or 14).

2. A lock as set forth in claim 1, characterized in that said grooves (12 and 14) are angularly displaced the one with respect to the other, with reference to the stator axis, by an angle of 90°.
